(19) United States
(12) Patent Application Publication
(10) Pub. No.: US 2025/0045593 A1
(43) Pub. Date: Feb. 6, 2025

(54) TEXTUALLY GUIDED CONSTRAINED POLICY OPTIMIZATION FOR SAFE REINFORCEMENT LEARNING

(71) Applicant: INTERNATIONAL BUSINESS MACHINES CORPORATION, ARMONK, NY (US)

(72) Inventors: Lan Ngoc HOANG, Timperley (GB); Lamogha Chiazor, Eastleigh (GB); Shivam Ratnakar, Ambarnath (IN); Minta Siharath, Arundel (GB)

(21) Appl. No.: 18/360,633

(22) Filed: Jul. 27, 2023

(51) Int. Cl. G06N 3/092

(52) U.S. Cl. CPC G06N 3/092

(57) ABSTRACT

A computer-implemented method increases the safety of a Reinforcement Learning (RL) agent operating with a text-based environment with safety constraints. The method incudes: obtaining safety hints from analysis of a textual model of the environment; based on the safety hints, using a dynamic constraint cost function for determining a constraint cost on actions taken by the RL agent in the environment; and operating the RL agent, using the safety hints and constraint cost, to determine an action to take.

### BACKGROUND

Reinforcement Learning (RL) is a machine-learning process that enables the discovery of an effective policy or set of policies for sequential decision-making tasks using trial and error. In the context of deep RL, an “agent” is a software program or algorithm that learns to interact with an environment, whether real or virtual, and to perform tasks in that environment. Specifically, the agent receives observations or sensory inputs from the environment, takes actions based on its policy or learned behavior, and receives feedback or rewards from the environment. The agent then adapts its policy based on the feedback. The goal of the agent is to maximize a cumulative reward over time, e.g., measured success in its assigned task, by learning optimal policies for performing the task through trial and error. The agent's learning process involves using deep neural networks (hence the term “deep” in deep RL) to approximate the value or action-value functions that help the agent make decisions. These neural networks are trained using RL algorithms, such as Q-learning, policy gradients, or actor-critic methods, to optimize their performance.

For example, deep RL agents have learned to play video and other games. RL agents have also learned to control robots, both in simulation and in the real world. For example, an RL agent may learn to control a robot for object manipulation from demonstrations and trial and error with feedback. Eventually, deep RL agents may perform any number of tasks, such as control of autonomous vehicles. However, as more control of real-world operations is given to RL agents, it will be essential to address any safety concerns.

The term “Constrained Policy Optimization” (CPO) refers to the incorporation of safety requirements and other constraints in deep RL agents. CPO seeks to ensure that the agent satisfies prescribed safety and other constraints at every step of the learning process. For example, a designer may assign a cost to each possible outcome that the agent should avoid in the tasks the agent is learning to perform. The designer may also assign limits to the costs the agent may incur. The agent then seeks to learn to perform the assigned tasks while keeping all costs below the prescribed limit. Open-source code for CPO is available at https://github.com/jachiam/cpo and is incorporated herein by reference.

### SUMMARY

According to an example of the present subject matter, A computer-implemented method increases the safety of a Reinforcement Learning (RL) agent operating with a text-based environment with safety constraints. The method incudes: obtaining safety hints from analysis of a textual model of the environment; based on the safety hints, using a dynamic constraint cost function for determining a constraint cost on actions taken by the RL agent in the environment; and operating the RL agent, using the safety hints and constraint cost, to determine an action to take.

In another example, the present description explains a Reinforcement Learning (RL) system that includes: an RL agent comprising a deep neural network, the RL agent for performing a task in an operating environment based on a policy optimized through trial and error; and a safety system for increasing safety of the RL agent based on specified constraints. The safety system includes: a safety concept net for entities in the operating environment, a safety hint generator for generating safety hints based on the safety concept net and a text model of the operating environment, and a dynamic constraint cost calculator to determine a constraint cost based on the safety hints. The safety system updates the RL agent based on the safety hints and constraint cost.

In another example, a computer program product includes a non-transitory computer-readable medium comprising instructions for a Reinforcement Learning (RL) agent operating in an operating environment with text-based safety constraints as dynamic costs. The instructions, when executed, provide a safety system for increasing safety of the RL agent based on specified constraints, the safety system including: a safety concept net generator to generate a safety concept net for entities in the operating environment, a safety hint generator for generating safety hints based on the safety concept net and a text model of the operating environment, and a dynamic constraint cost calculator to determine a constraint cost based on the safety hints. The safety system updates the RL agent based on the safety hints and constraint cost.

### BRIEF DESCRIPTION OF THE DRAWINGS

FIG. 1 depicts a computing environment for the execution of a computer-implemented method or application, according to an example of the principles described herein.

FIG. 2 is a flowchart depicting a method of increasing the safety of an RL agent according to principles described herein.

FIG. 3A depicts an example of an RL agent interacting with an operating environment according to principles described herein.

FIG. 3B depicts updating an RL agent for safe action selection according to an example of the principles described herein.

FIG. 4 depicts a Safety Concept Net Graph according to an example of the principles described herein.

FIG. 5 is a flowchart for a process of generating safety hints and safety hint actions, according to an example of the principles described herein.

FIGS. 6 and 7 depict results of the operation of an RL agent according to examples of the principles described herein.

FIG. 8 depicts a computer program product according to an example of the principles described herein.

### DETAILED DESCRIPTION

As more control of real-world operations is given to RL agents, it will be necessary to address safety concerns. As used herein and in the appended claims, the term “policy” refers to the approach the RL agent takes in performing its assigned task. The policy may be defined in terms of variable values, decision trees and other data structures that an agent applies, effectively or ineffectively, in performing the assigned task. As noted above, an RL agent is trained to adopt a succession of policies with the goal of maximizing a resulting reward that is determined and reported to the RL agent based on a design of the learning process created by a human designer. The goal is for the RL agent to eventually converge on an optimal policy that is both highly effective in terms of the defined reward and also safe. However, if the reward signal is not properly designed, the agent may learn unintended or even potentially dangerous behavior.

The issues with training an RL agent can be appreciated from a basic example. In this example, a mobile robot is trained to move within a bounded area. For example, the robot may be performing a cleaning of the bounded area. In this example, the robot may be assigned rewards based on how quickly it moves around the bounded area without leaving the area. However, if this reward function is the only guide the agent has to optimize its behavior, any errors in the reward design can cause the agent to be too risk averse or too risk prone, either of which will decrease the utility of the robot.

Ultimately, the design of the reward function may result in the agent exhibiting effective and safe behavior. However, the RL agent must learn through trial and error by exploring many different alternative policies before converging on an optimized policy. Thus, even if the agent eventually finds and settles on a safe policy using the reward function, this may still result in unsafe behavior, dangerous outcomes and damages between the beginning and end of the training. If the training is occurring in the real world, this presents obvious issues.

Because designing appropriate reward functions is inherently difficult, the use of constraints, as in CPO, helps compensate for any unintended issues in the reward signal. Consequently, constraints are also used in conjunction with the reward function. For example, the robot is considered “safe” if the frequency of its departures from the bounded area are less than a set limit within a given time period. This additional guide to optimized behavior compensates for potential issues in the design of the reward function and limits unsafe behavior by the agent during and after the learning process.

As the agent utilizes trial and error to identify optimized policies, a standard practice is local policy search. This simply means that each new policy tried is similar, in some respect, to a previous policy. Two different approaches to performing a local policy search include policy gradient methods and trust region methods. Policy gradient methods try new policies by taking small steps in the direction of a gradient of performance along which the reward value increases. Trust region methods also use policy gradients, but specifically require that each new policy is similar to a previous policy in terms of average KL-divergence. KL-divergence is an existing method of determining how different two probability distributions are from each other. Because policies output probability distributions over actions, KL-divergence is a natural way to measure the similarity between policies.

CPO is a trust region method for constraining RL that applies the established constraints for each policy update. Using approximations of the constraints to predict how much the associated costs might change for any given policy iteration, CPO selects a policy update that will most improve performance measures while keeping the constraint costs within the established limits. For example, a policy gradient may indicate a direction in which a policy can be adjusted to increase reward, for example, changing a variable associated with the policy. The theoretical optimal next step then lies on the edge of a KL trust region in the direction indicated by the policy gradient. However, that point (A) may lie beyond applied safety constraints. Accordingly, the next policy iteration will be as close to point (A) as possible while remaining within the applied constraints. In this way, CPO guides each policy iteration of the learning process to maintain the safety defined by the applied constraints.

Previously, the constraints imposed in CPO have been specified in mathematical form. Specifying RL constraints mathematically requires domain expertise. This limits the adoption and use of RL where safety is a concern. More recently, work has been done to integrate natural language processing into an RL agent so that constraints can be specified using natural language rather than mathematical expressions. Such an agent may have a modular architecture that includes both a constraint interpreter and a policy network. The constraint interpreter encodes textual constraints into spatial and temporal representations of forbidden or unsafe states. The policy network uses these representations in the trial and error process described above to produce an optimized policy that achieves minimal constraint violations while maximizing the specified reward.

Natural Language Processing (NLP) is a subfield of artificial intelligence that has been evolving for decades sparked by early efforts to provide machine translations of one human language into another. Most recently, NLP techniques have been included in Large Language Models (LLMs) such as Generative Pre-Trained Transformers (GPT) where textual instructions can be provided to an Artificial Intelligence (AI) that returns a sophisticated textual response. In the context of the constraint interpreter of an RL agent, the RL agent can be trained using NLP techniques to have a text-based understanding of objects, their characteristics and/or proper relationships.

The semantic analyzer described herein determines semantic distance. Semantic distance refers to the measure of the conceptual or contextual difference between two or more entities, such as words or phrases, based on their meaning or semantic content. It quantifies the degree of similarity or dissimilarity between these entities in terms of their semantic properties. Determining semantic distance is a part of NLP that involves capturing and comparing various aspects of meaning, such as the relationships between words, the contextual usage, and the overall semantic structure. There are several different methods and approaches to measure semantic distance, any of which might be used in the techniques described below. These include: path-based methods that operate on structured representations of language, such as ontologies or knowledge graphs; distributional methods that rely on the statistical analysis of large corpora of text to determine the semantic similarity between words; information-theoretic methods that leverage information theory to quantify the semantic distance between words; word embeddings that use dense vector representations that capture semantic properties of words; and machine learning approaches.

A technical problem presented by the current state of RL agents is to improve the safety of an RL agent that is trained using textual constraints. For example, current methods of RL do not consider the dynamic safety levels presented in textual forms. For example, the state of an object, specified in text, may change as may the safety concerns associated with that object in its current state. For example, a stove that is “off” may not present a safety concern, but a stove that is “on” may present a fire risk. The safety level of the stove is consequently dynamic based on its current state which may be determined by sensory output and/or specified in text. Thus, considering dynamic safety levels can provide more information on whether safety concerns are high in the current state of the system.

As a technical solution to this technical problem, the following description proposes providing an RL agent with text-based guidance of safety constraints as dynamic costs based on a semantic-distance between the currently described state of any object or system and its unsafe states. This can be done in three steps: (1) The textual model provides safety hints and an estimation of state-based costs based on the cost constraints 250. (2) The RL agent, using CPO, uses these hint action commands to perform a line search for the best actions to take 251. (3) Both the dynamic textual-model and the RL agent are updated 252. The output is a dynamic method to provide safety level guidance to the RL agent based on a textual description.

The generation of the safety hints and estimate of state-based cost will be described in further detail below. With these inputs, as described above, the RL agent selects actions to take based on expected rewards or to achieve a specific goal. A line search is a numerical optimization method used to search along a particular direction in a parameter space. In the context of RL, the line search technique is employed to search along a line or trajectory of possible actions the agent can take in order to find the best action or sequence of actions that maximizes the expected rewards. During a line search, the RL agent explores different actions along the line and evaluates their potential outcomes by estimating the expected rewards or value associated with each action. The agent typically uses a model or an estimation mechanism, such as a value function or a policy network, to approximate the expected rewards. By iteratively evaluating and comparing the expected rewards along the line, the agent can determine the action that leads to the highest expected rewards or the most desirable outcome.

Accordingly, the following description provides a method of generating safety hints and hint action commands based on a safety concept net and semantic similarities. This provides a dynamic method or provide safety level guidance based on a textual description and internal RL agent action selection to help with closing loops on actions to converge on an optimized policy. This approach also provides a way to dynamically update a constraint cost used by the RL training that is based on the generated safety hint commands, i.e., a constraint update. This approach also provides a method of updating an RL agent based on the safety constraints predicted by the semantic similarities to unsafe concepts and safety hints.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse or any given order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

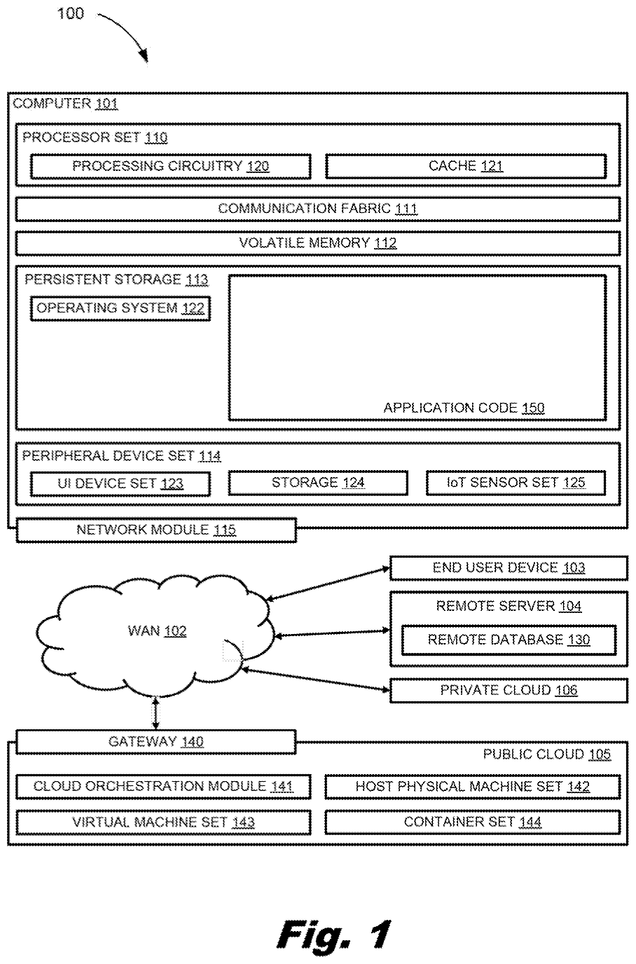

Turning now to the figures, FIG. 1 depicts a computing environment 100 in which an RL agent according to the principles described herein may be trained and then operate. Computing environment 100 contains an example of an environment for the execution of at least some of the computer code involved in performing the inventive methods, an application to provide context specific recommendations to producers regarding the satisfaction of their users. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

The EUD 103 may be a client device operated by a producer of services or products that wants an analysis of available user data to ascertain user satisfaction. Operation of the EUD 103 for this objective will be described in further detail below.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

As described further below, the EUD 103 may use the network 102 to access an application on remote server 104. The application will access, again using the network 102, available user data. The application will then analyze the user data, with context specific analysis, to ascertain user satisfaction and generate recommendations for the producer based on the analysis.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

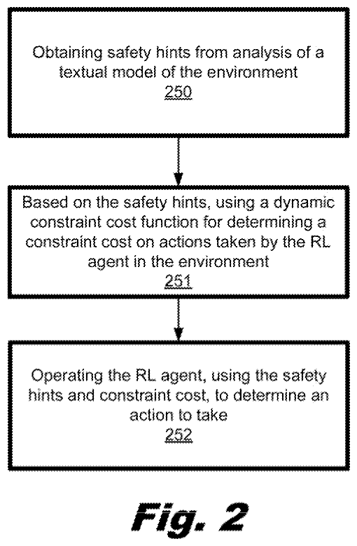

FIG. 2 is a flowchart showing a method according to principles described herein. As shown in FIG. 2, a safety system for an RL agent may operate by (1) obtaining safety hints from analysis of a text model of the operating environment 250; (2) based on the safety hints, using a dynamic constraint cost function to determine a constraint cost on actions to be taken by the RL agent in the operating environment 231; and (3) while operating the RL agent, using the the safety hints and constraint cost to determine an action for the RL agent to take 252.

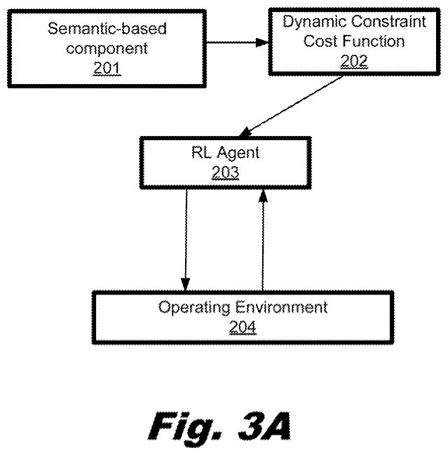

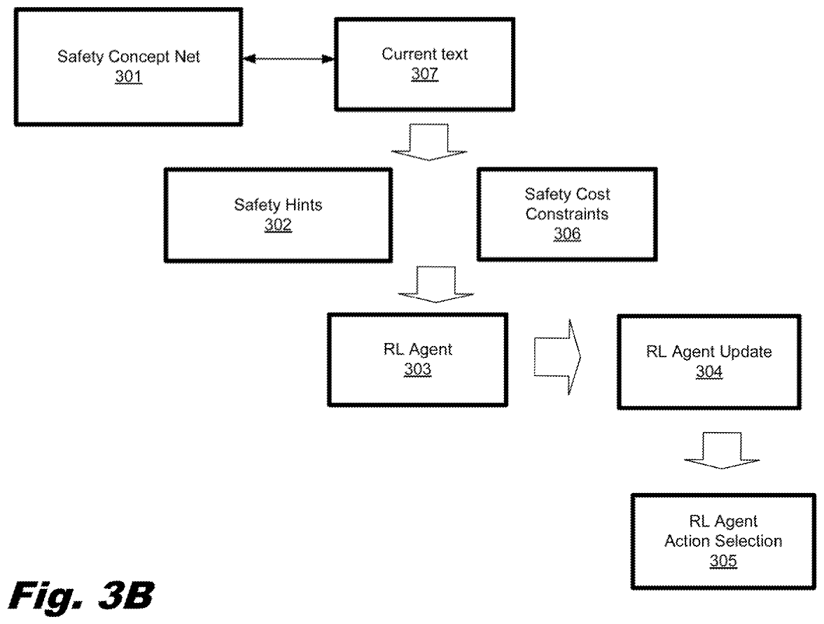

FIG. 3A depicts basic components in an example of the principles described herein. As described above, the operating environment of the RL agent may be text based or a textual representation of a real-world environment. Also, the safety based constraints that are to limit the actions chosen by the RL agent are specified in text.

As shown in FIG. 3A, a semantic-based component 201 may use NLP to operate on the safety constraints specified in text for the RL agent to output a dynamic constraint cost function 202, which will be described in further detail below. The dynamic constraint cost function 202 is incorporated into the RL agent 203. The RL agent 203 then takes action in an operating environment 204 and receives feedback defining the results of the selected action. As described above, trial and error iterations of the agent 203 acting in the operating environment 204 train the agent 203 to an optimized policy for operating safely. Again, the operating environment may be a textual environment, such as a game construct, in which the agent 203 can demonstrate an ability to learn and operate safely before being used in a real-world operating environment. Alternatively, the operating environment may be a textual description of the real-world situation in which the RL agent is operating.

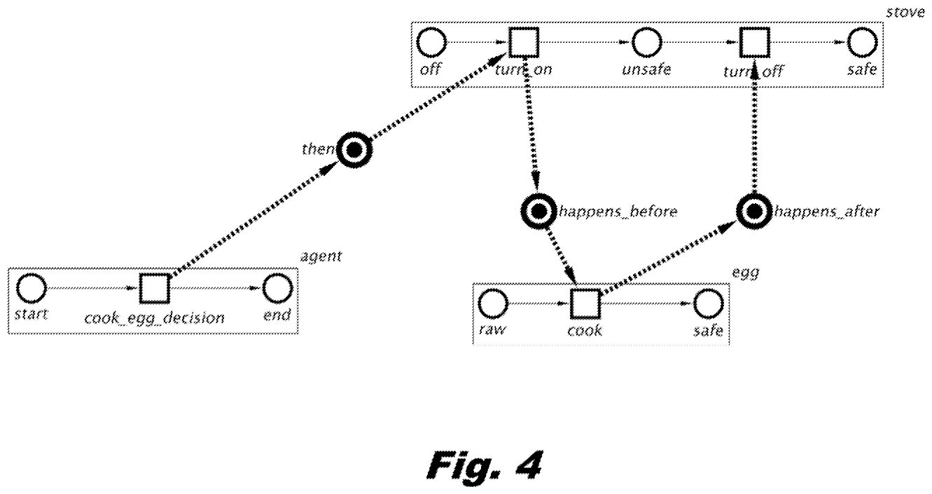

FIG. 3B depicts the components and their relationships in an example of the principles described herein. As shown in FIG. 3B, the current text 307 defining the operating environment will include objects that potentially have safe and unsafe states and may change dynamically between these states as actions are taken. This information is captured in a safety concept net 301. The safety concept net can also be represented as a safety concept net graph (SNCG), an example of which is shown in FIG. 4 and will be discussed below.

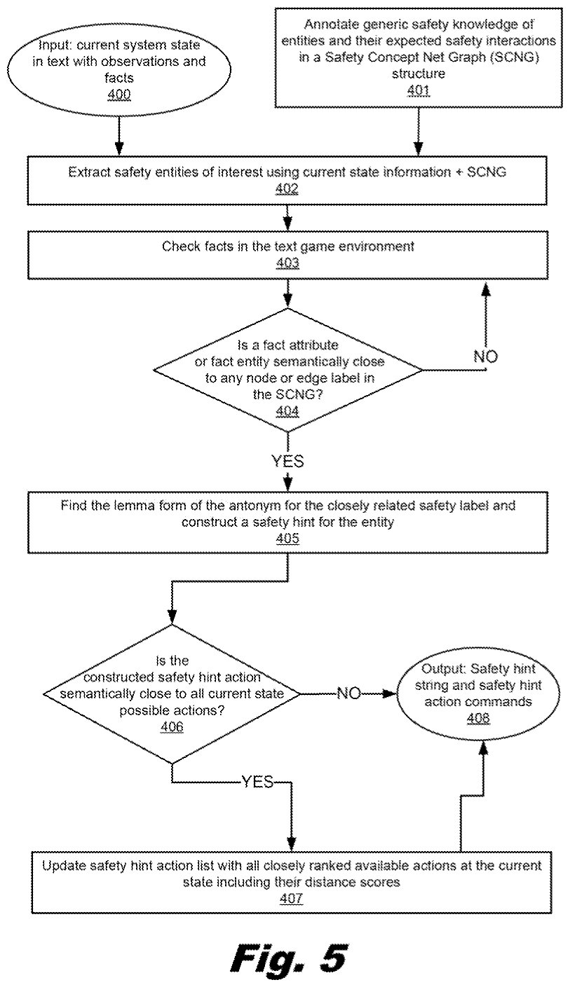

From the current text 307 and the corresponding safety concept net 301, a number of safety hints 302 are generated. The production of the safety hints will be described in greater detail below in connection with FIG. 5. From these safety hints and the corresponding safety action commands, a set of safety cost constraints 306 are generated. An example of a dynamic constraint cost function that can be used to produce the safety constraint cost will also be described below.

The RL agent 303 is updated 304 with the safety cost constraints. As a result, the RL Agent action selection 305 is guided by the safety cost constraints to produce a safer operation of the RL agent.

As noted above, FIG. 4 is an example of a safety concept net graph (SNCG). In this example, the task for the RL agent is to cook an egg. Thus, as shown to the left of the figure, the agent is represented with start and end points, between which is the task “cook_egg_decision.” The egg and stove are also represented in the figure. The egg has a raw state, can receive the action of cooking and is then in a safe state. The stove can be turned on or off. When turned on, the stove is unsafe. After being turned off, the stove is again in a safe state.

The action lines connecting the entities show the flow of the task. The agent first turns on the stove. This happens before the egg can be cooked. The egg is then cooked and attains a safe state. The stove is then turned off, also thereby attaining a safe state.

FIG. 5 is a flowchart showing the use of the SNCG in generating safety hints and safety hint action commands. As shown in FIG. 5, the process begins with an input which is the current system state, in text, with observations and facts 400. As an additional input, generic or “commonsense” safety knowledge of the entities in the operating environment and their expected safety interactions are captured in an SNCG 401. This can be manually constructed or imported from a system dynamic type model. Alternatively, it can be from a Machine Learning model which learns from a safety/commonsense database and is trained to output safety rules/interactions.

From these inputs, the process extracts 402 entities of interest that present possible safety concerns. This is based on the current state information and the SNCG. The process then checks facts 403 in the operating environment. This may be a text game environment in which the RL agent is being tested or trained, but may also eventually be a real-world environment from which the RL agent receives sensory input to define the current state of the operating environment. Such sensory input may be converted into a textual form for processing by the RL agent.

The process then determines 404 if a fact attribute or fact entity is semantically close to any node or edge label in the SCNG. In the example of cooking an egg, a fact entity is an “egg” and a fact attribute is “raw” as in a “raw egg.” Semantically close in the diagram is defined by a threshold such as the similarity distance score between a safety hint and an available action is >=0.5. If no fact attribute or fact entity is semantically close to any node or edge label of the SCNG, there is no immediate safety concern, and the process returns to monitoring the dynamic state of the operating environment, e.g., a text game environment. If a fact attribute or fact entity is semantically close to a node or edge label in the SCNG, the process continues by finding 405 the lemma form of the antonym for the closely related node or edge label and then constructing a safety hint for the entity. For example, the antonym for “raw” is “cooked.” Thus, a safety hint where the egg is raw would be “cook egg.”

The process then determines 406 whether the constructed safety hint and corresponding action are semantically close to all current state possible actions. If not, the safety hint string and safety hint action commands are output 408. If semantically close, the process updates 407 the safety hint action list with all the closely ranked available actions in the current state of the operating environment including their distance score. The process then outputs the safety hint string and safety hint action commands 408.

Once the number of safety hint action commands has been determined by this process, a dynamic constraint cost function is used. For example:
If the number of safety hint commands is zero:
   Constraint Cost=0.001 k where k is the hidden size
If the number of safety hint commands is nonzero;

$$\\ Constraint Cost = \frac{No . of actions mod No . of safety hint commands}{100 * No . of safety hint commands}$$

If the number of actions mod No of Safety hints is zero:
   Constraint Cost=0.005 k where k is the hidden size
For example:
Let there be 13 actions, and 2 safety hint commands in the current state.
   The Constraint cost will be

$$\\ \frac{13 mod 2}{2 * 100} = 0.005$$

Let the safety hint commands increase to 7 in the current state.
   The Constraint cost will be

$$\\ \frac{13 mod 7}{7 * 100} = 0.009 ( 3 dp )$$

As noted above, the constraint cost is then used to update and guide the RL agent in safe training or operation. Since the safety hint can correlate to the current safety level of the action command or the target state, that means the process can use these to tighten or relax the constraints. For example, if the risk is high, the constraints are to be closer to 1 so that the algorithm can enforce the constraints and the agent stays closer to the safe region.

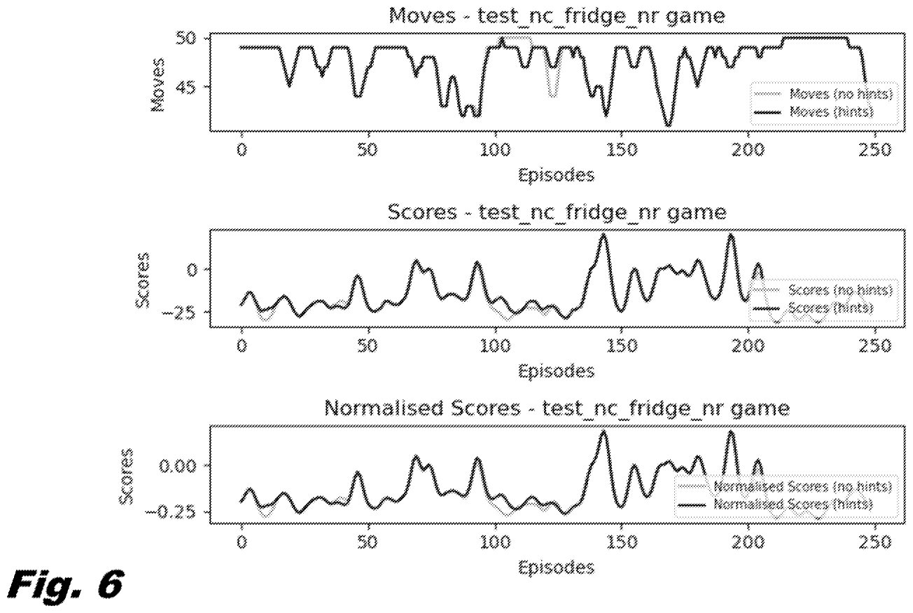

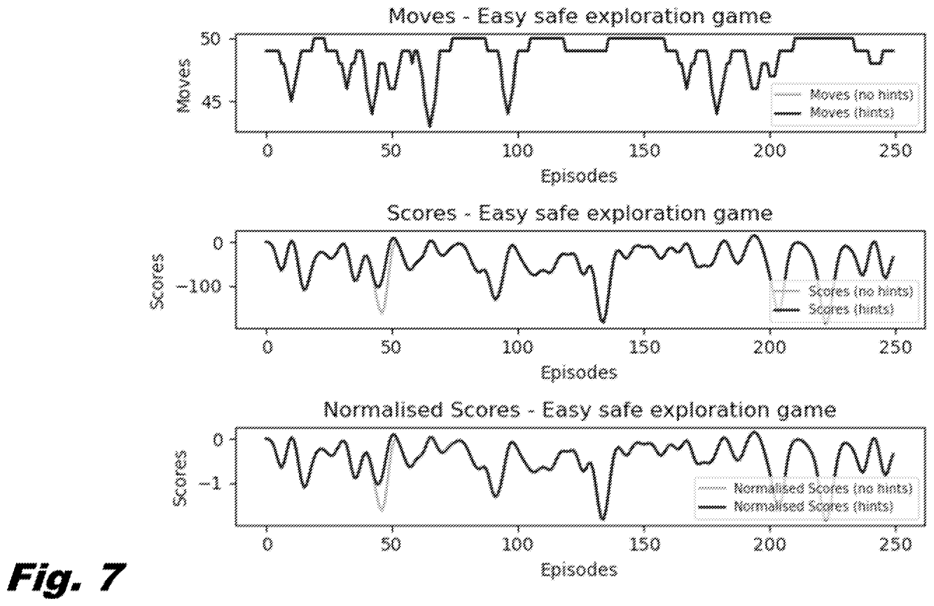

FIGS. 6 and 7 illustrate the results of an RL agent playing a text game. Experiments were performed using two different games. The first game was a dense reward game, with the goal of cooking an egg and eating it. This game penalizes the agent if the stove is on and the fridge is open. The second game was a sparse reward game with a goal to cook an egg and put it in a lunch box, with no penalty for opening a fridge or turning on the stove.

FIG. 6 shows plots from the agent playing the dense reward game. FIG. 7 shows plots from the agent playing the sparse reward game. Both set of plots show the operation of the agent with and without the use of safety hints as described herein. In both instances, the use of safety hints in a text-based operating environment provided improved safety performance by the RL agent. From the result plots for the games, we observe that the RL agent with the generated safety hints (dark line) improves performance compared to the baseline without safety hints (light lines) in both the dense and sparse reward games.

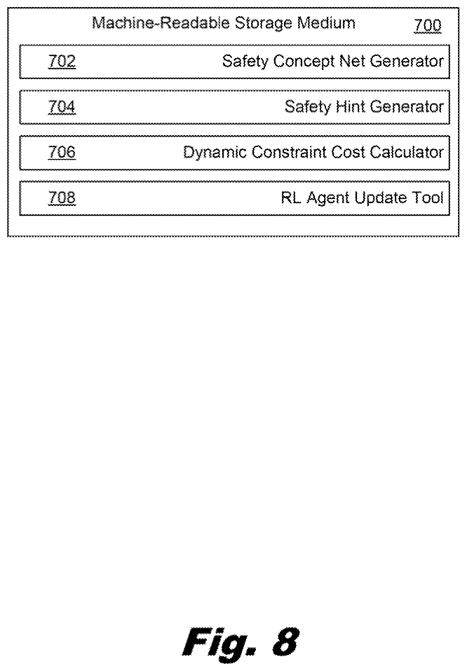

FIG. 8. illustrates a computer program product comprising a non-transitory machine-readable storage medium 700 storing instructions for a Reinforcement Learning (RL) agent operating in an operating environment with text-based safety constraints as dynamic costs. The instructions, when executed, provide a safety system for increasing safety of the RL agent based on specified constraints. Consistent with the component and functionality described above, the safety system includes: a safety concept net generator 702 to generate a safety concept net for entities in the operating environment, a safety hint generator 704 for generating safety hints based on the safety concept net and a text model of the operating environment, and a dynamic constraint cost calculator 706 to determine a constraint cost based on the safety hints. The safety hint generator 704 may operate using the process illustrated in FIG. 5. The dynamic constraint cost calculator 706 may operate using the dynamic constraint cost function described above. The system may also include an RL agent update tool 708 to update the RL agent based on the safety hints and constraint cost.

As used in the present specification and in the appended claims, the term “a number of” or similar language is meant to be understood broadly as any positive number including 1 to infinity.

What is claimed is:

1. A computer-implemented method of increasing safety of a Reinforcement Learning (RL) agent operating with a text-based environment with safety constraints, the method comprising:
obtaining safety hints from analysis of a textual model of the environment;
based on the safety hints, using a dynamic constraint cost function for determining a constraint cost on actions taken by the RL agent in the environment; and
operating the RL agent, using the safety hints and constraint cost, to determine an action to take.

2. The method of claim 1, wherein the RL agent performs a line search governed by the safety hints and constraint cost to determine an action to take.

3. The method of claim 1, further comprising based on a result of the action, updating the textual model and the RL agent.

4. The method of claim 1, further comprising obtaining the safety hints from the textual model using a safety concept net and semantic similarities.

5. The method of claim 1, wherein obtaining the safety hints comprises:
generating a Safety Concept Net Graph (SCNG) data structure using generic safety knowledge of entities and expected safety interactions in the environment;
based on current state information of the environment, extract safety entities of interest using the SCNG;
determine if a fact attribute of an entity of interest is semantically close to any node or edge in the SCNG;
when a fact attribute of an entity of interest is semantically close to any node or edge in the SCNG, generate a corresponding safety hint.

6. The method of claim 5, wherein, when a fact attribute of an entity of interest is semantically close to any node or edge in the SCNG, generating a corresponding safety hint by:
finding a lemma form of an antonym for the semantically close node or edge; and
construct the corresponding safety hint based on the antonym.

7. The method of claim 5, further comprising updating a safety hint action list with all semantically close available actions in the current state of the environment.

8. A Reinforcement Learning (RL) system, comprising:
an RL agent comprising a deep neural network, the RL agent for performing a task in an operating environment based on a policy optimized through trial and error; and
a safety system for increasing safety of the RL agent based on specified constraints, the safety system comprising;
a safety concept net for entities in the operating environment,
a safety hint generator for generating safety hints based on the safety concept net and a text model of the operating environment,
a dynamic constraint cost calculator to determine a constraint cost based on the safety hints,
wherein the safety system updates the RL agent based on the safety hints and constraint cost.

9. The system of claim 8, wherein the specified constraints are in text form.

10. The system of claim 8, wherein the operating environment is textual.

11. The system of claim 8, wherein the safety hint generator comprises a semantic analyzer to generate the safety hints based on the safety concept net and a text model of the operating environment.

12. The system of claim 11, wherein:
the safety concept net comprises a Safety Concept Net Graph (SCNG); and
the semantic analyzer determines semantic closeness between an entity attribute and any node or edge of the SCNG to generate a safety hint.

13. The system of claim 12, wherein, when the closeness between the entity attribute and a node or edge of the SCNG is within a threshold, the semantic analyzer determines a lemma form of an antonym for the entity attribute to generate the safety hint.

14. The system of claim 12, wherein the semantic analyzer determines how semantically close the safety hint is to all current possible actions the RL agent may take to generate a safety hint action command.

15. A computer program product comprising a non-transitory machine-readable storage medium comprising instructions for a Reinforcement Learning (RL) agent operating in an operating environment with text-based safety constraints as dynamic costs, the instructions, when executed, providing a safety system for increasing safety of the RL agent based on specified constraints, the safety system comprising;
a safety concept net generator to generate a safety concept net for entities in the operating environment,
a safety hint generator for generating safety hints based on the safety concept net and a text model of the operating environment, and
a dynamic constraint cost calculator to determine a constraint cost based on the safety hints,
wherein the safety system updates the RL agent based on the safety hints and constraint cost.

16. The product of claim 15, wherein the specified constraints are in text form.

17. The product of claim 15, wherein the safety hint generator comprises a semantic analyzer to generate the safety hints based on the safety concept net and a text model of the operating environment.

18. The product of claim 17, wherein:
the safety concept net comprises a Safety Concept Net Graph (SCNG); and
the semantic analyzer determines semantic closeness between an entity attribute and any node or edge of the SCNG to generate a safety hint.

19. The product of claim 18, wherein, when the closeness between the entity attribute and a node or edge of the SCNG is within a threshold, the semantic analyzer determines a lemma form of an antonym for the entity attribute to generate the safety hint.

20. The product of claim 18, wherein the semantic analyzer determines how semantically close the safety hint is to all current possible actions the RL agent may take to generate a safety hint action command.
